(19) United States
(12) Patent Application Publication
(10) Pub. No.: US 2006/0209046 A1
(43) Pub. Date: Sep. 21, 2006

(54) Integrally formed monitor having one or more touchpads as function keys

(76) Inventor: Kuan-Chun Tang, Toufen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/284,821

(22) Filed: Nov. 23, 2005

(30) Foreign Application Priority Data
Mar. 17, 2005 (TW) 094204129

(51) Int. Cl. G09G 5/00

(52) U.S. Cl. 345/173

(57) ABSTRACT

An integrally formed monitor comprises one or more touchpads to provide function keys, and therefore projecting structure for function keys to be pressed by users is not necessary for the monitor owing to the touch-sense feature of the touchpad.

### FIELD OF THE INVENTION

The present invention is generally related to a monitor and, more particularly, to a monitor having one or more touchpads as function keys.

### BACKGROUND OF THE INVENTION

For a current monitor, solid keys are used as function keys for the setting adjustment of the monitor by users, which are usually positioned at the front side of the monitor, no matter liquid crystal display (LCD) monitor or cathode ray tube (CRT) monitor. FIG. 1 shows a conventional monitor 100 comprising a screen 102 and several function keys 104-112, among which power key 112 is used to turn on and off the monitor 100. When the monitor 100 is powered on, a blank picture will be displayed on the screen 102, which defines the available display range on the monitor 100. Then, a menu 114 may be shown on the screen 102 if a menu key 104 is pressed by users. Subsequently, an item to be set may be selected with the movement of a highlight area 116, which is accomplished by means of minus (“−”) key 108 and plus (“+”) key 110 operated by users. After one item, such as volume, is selected, and enter key 106 is then pressed, a volume control bar 118 is shown on the screen 102 at the moment. Again, the minus (“−”) key 108 and plus (“+”) key 110 are used by users to tune the volume. Setting for other functions may be deduced by analogy. The function keys of this type for the monitor must be presented as a projecting structure to be pressed by users; however, integral appearance is thus impossibly obtained.

Therefore, it is desired a more attractive and integrally formed monitor.

### SUMMARY OF THE INVENTION

An object of the present invention is to provide an integrally formed monitor, which employs one or more touchpads as function keys.

In accordance with the present invention, one or more touchpads may be used as function keys in an integrally formed monitor. Projecting structure for function keys to be pressed by users is not necessary for the monitor owing to the touch-sense feature of the touchpads, in such a way that an integral and attractive appearance may be obtained for the monitor so as to satisfy the market demand.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional monitor; and

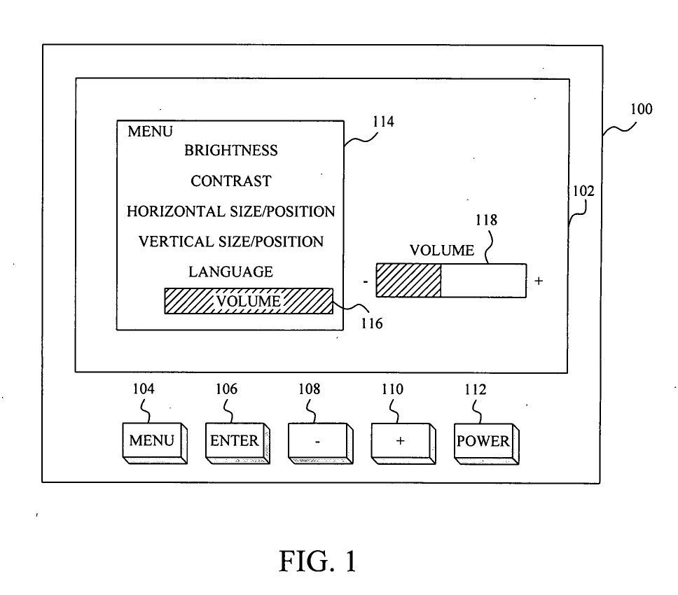

FIG. 2 shows an integrally formed monitor according to the present invention.

### DETAILED DESCRIPTION OF THE INVENTION

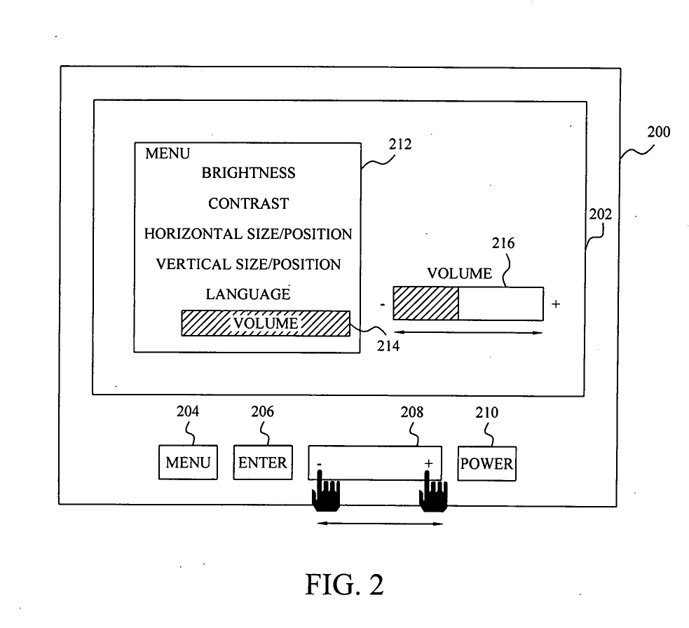

FIG. 2 shows an integrally formed monitor 200 according to the present invention, which comprises a screen 202 and a plurality of function keys 204-210 provided by one or more touchpads. Among the function keys 204-210, power key 210 is used to turn on and off the monitor 200. When the monitor 200 is turned on by touching the power key 210, a blank picture is displayed on the screen 202 that shows the available display range on the monitor 200. Then, a menu 212 may be shown on the screen 202 if the menu key 204 is touched by users. Subsequently, by sliding a finger on the plus/minus (“+−”) touch scroll bar 208, a highlight area 214 is thus moved. For instance, the highlight area 214 is moved upward when the finger may either slide toward the plus (“+”) direction, or click once on or touch-and-hold at the location of the plus (“+”); on the contrary, the highlight area 214 is moved downward when the finger may either slide toward the minus (“−”) direction, or click once on or touch-and-hold at the location of the minus (“−”). After one item, such as volume, is selected, and the enter key 206 is then touched, a volume control bar 216 is shown on the screen 202 at the moment. The volume may be tuned by sliding the finger on the plus/minus (“+−”) touch scroll bar 208. For instance, the increased volume is presented when the finger may either slide toward the plus (“+”) direction, or click once on or touch-and-hold at the location of the plus (“+”); on the contrary, the decreased volume is presented when the finger may either slide toward the minus (“−”) direction, or click once on or touch-and-hold at the location of the minus (“−”). Setting for other functions may be deduced by analogy.

Each of the function keys 204-210 is a region which, defined on the touchpad, may be printed or attached thereon with a corresponding pattern of the function key, in case that these function keys are provided by one touchpad.

The thickness of monitor may be reduced and the power consumption thereof may be lowered when the conventional solid keys are replaced by touchpad, since the thickness of touchpad is much thinner than that of conventional solid keys and the power consumption thereof is lowered.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An integrally formed monitor comprising:
one or more touchpads for providing a plurality of function keys.

2. The monitor according to claim 1, wherein the plurality of function keys comprise a touch scroll bar.

3. The monitor according to claim 1, wherein the plurality of function keys comprise a menu key for calling out a function menu.

4. The monitor according to claim 1, wherein the plurality of function keys comprise a power key for turning the monitor on and off.
